(19) United States
(12) Patent Application Publication
(10) Pub. No.: US 2005/0086368 A1
(43) Pub. Date: Apr. 21, 2005

(54) System and method for determining nearest neighbor information

(75) Inventor: Robert L. Winter, Georgetown, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 10/685,851

(22) Filed: Oct. 15, 2003

(51) Int. Cl. G06F 15/173

(52) U.S. Cl. 709/239

(57) ABSTRACT

A communications network is disclosed in which network nodes transmit messages between each other in order to determine which nodes are physically linked. The messages include information identifying the sending node and port. As messages are received by nodes, the information within the messages is logged. The logged information is collected by an administrator. The administrator uses the collected data to determine a network topography. The network topographies may be used to determine failures within the network.

### TECHNICAL FIELD

The present disclosure relates generally to the field of communication networks, and, more particularly, to a system and method for nearest neighbor discovery in a network.

### BACKGROUND

As the value and use of information continues to increase, individuals and businesses seek additional ways to process and store information. One option available to users of information is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may comprise a single node or a group of nodes in a computer network. The nodes may be coupled to one another by one or more physical links and one or more switching devices. Switching devices have a plurality of ports, each port capable of accepting a physical connection. As the number of computers, physical links, routers, and switching devices increase, network administration and troubleshooting may become more complicated.

When discussing computer networks, the International Standard Organization's Open System Interconnect (ISO/OSI or OSI) network model is useful for clarifying computer network operation. The OSI network model includes seven layers. The two layers that are the most relevant to the present disclosures are Layer 3, which is known as the network layer and generally involves datagram routing from one network to another, and Layer 2, which is known as the data link layer and generally involves data frame transfer within a network. Devices in a network, including, for example, switches, routers, and computers, may operate at one or more levels of the OSI model.

Standard protocols exist for determining the Layer 3 connections between network devices. These methods, however, are only available to devices that operate at Layer 3. As a consequence, these methods do not allow discovery of physical connections, including for example, the illustration or identification of those ports in a first node that are directly coupled to ports in a second device. While troubleshooting a network, it is often necessary to determine the precise physical interconnections between network devices. Determining the Layer 2 connections of a network is useful in isolating defects or other anomalies in a network, mapping the network topography, and performing other network administration tasks. Although proprietary protocols exist to identify characteristics of physical links between Layer 2 network devices, these protocols, however, may be more sophisticated than necessary for many network maintenance tasks, thereby introducing bandwidth constraints and unnecessary complexity in the network.

### SUMMARY

In accordance with the present disclosure, a communications network is disclosed that includes at least one first node, the first node including at least one port. The first node transmits a message consisting of only one frame from the port. The message sent from the first node is addressed to an address. The address is known by both nodes. The first node receives a second message on the port. The second message is only one frame in length. The second message originates from a second node, which includes at least one port. The second message includes identification information about the second node. The first node is also capable of logging the identification information about the second node and delivering the identification information to an administrator. This frame exchange occurs between two nodes that are directly connected by a physical link. Based on the identification information, the administrator identifies the physical interconnection between the first and second nodes. The communications network uniquely identifies all ports, together with associated nodes that are connected to a given node.

A technical advantage of the present disclosure is that the determination of nearest neighbors in a network takes place at Layer 2, allowing the discovery of which first port is physically connected to a second port. The nodes exchange messages containing information about the nodes. The messages are received, and the information contained therein logged. At a later time, the administrator collects the logged information and determines the network topography. Another technical advantage of the present disclosure is that messages sent between nodes need not be taxing on the network. The messages transmitted between nodes are short, preferably only one frame in length. Furthermore, there is a delay between when a first message is sent and when a second message is sent, so that these messages will not flood the network. Finally, the transmission of messages may be started and stopped by a user, so that messages will only be transferred when the user gives a command. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a communications network;

FIG. 2 is a timing diagram of transmissions between nodes;

FIG. 3 is a flow diagram of the steps of transmitting information messages, receiving information messages, logging information messages, and delivering information messages in a node in the network; and

FIG. 4 is a diagram of a communications network.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a person computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. Information handling systems may include one or more nodes in a network.

The present disclosure concerns a system and method for determining the nearest neighbor in a network. A nearest neighbor is a node that is physically interconnected to a subject node and which, in addition, is able to communicate with subject node according to the method described herein. Disclosed herein is a network that includes at least one node or information handling system that is capable of transmitting identification messages containing sufficient information to identify itself to other nodes. In addition, the node or information handling system is capable of receiving identification messages identifying other network nodes. Because the identification steps are performed at Layer 2 of the OSI network model, the physical connections between ports on nodes may be determined.

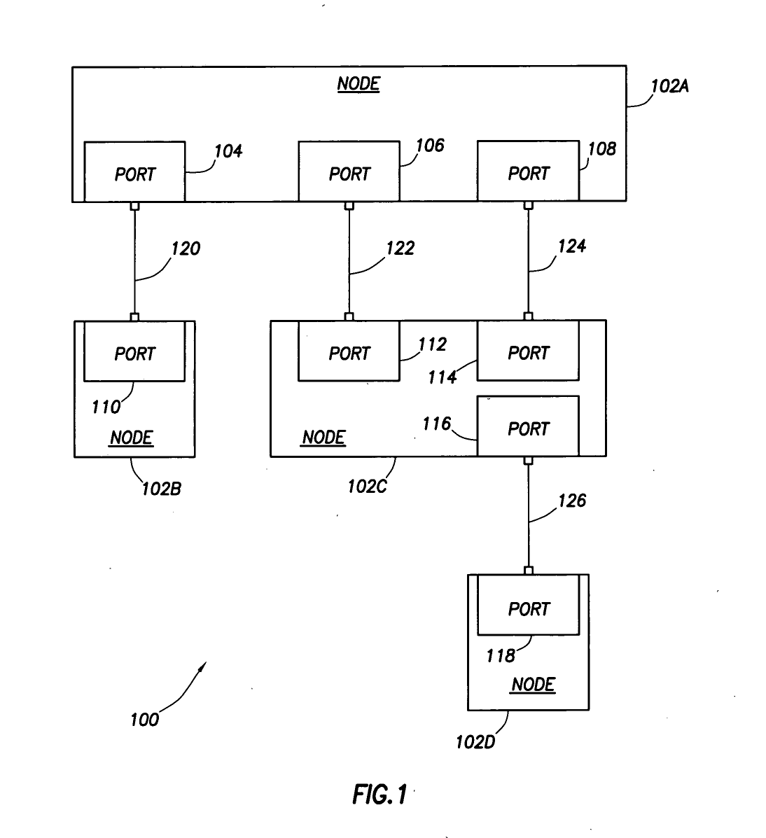

Shown in FIG. 1 is a communications network, which is indicated generally at 100. Communications network 100 may be a home network or a business network. In one embodiment, communications network 100 is an Ethernet LAN. Communications network 100 includes four nodes 102A, 102B, 102C, and 102D. Nodes may have one or more ports. For example, node 102A includes ports 104, 106, and 108; node 102B includes only a single port 110; node 102C includes ports 112 and 114; and node 102D includes port 118. Each node typically includes a processor and memory. Each of the ports may receive frames addressed to one or more addresses. For example, each of the ports may receive frames addressed to a unicast address, a multicast address, or a broadcast address. Upon reception by the port, the node may process, drop, or forward a frame. Typically, only received frames that are sent to certain addresses are processed by the node. The port is said to be bound to these addresses. If a port receives a frame addressed to an address it is not bound to, it may drop or forward the frame. Each port may be bound to a unique unicast address, and generally, only that port will accept a frame addressed to the unicast address. A group of ports, however, may be bound to a multicast address, and each of the ports will accept frames addressed to the multicast address. Typically, all ports will accept frames addressed to the broadcast address. Each of the ports may transmit to one or more addresses. For example, each of the ports may transmit frames addressed to a unicast address, a multicast address, or a broadcast address. Each port may be physically connected to another port. In FIG. 1, port 104 is physically connected to port 110 by a communications link 120; port 106 is physically connected to port 112 by a communications link 122; port 108 is physically connected to port 114 by a communications link 124; and port 116 is physically connected to port 118 by communications link 126. Each of the communication links may be a hard-wired connection, e.g. Category 5 or optical cable, or a wireless connection. Each of the nodes 102A, 102B, 102C, and 102D may transmit a message from one of its ports to a connected port. The message may include one or more frames. Typically, each frame consists of 1,500 bytes.

In operation, a first node will send one or more identification messages, each including one or more frames, from a first port, addressed to a reserved multicast address. Each identification message contains identification information about the first node, including, for example, a Media Access Control (MAC) address of the first node, an Internet protocol (IP) address of the first node, and a first port identifier. Each identification message may contain characteristic information about the first node or first port, including, for example, a class of device, e.g. hub, switch, router, client, or server, a model of the first node or first port, a firmware version of the first node or first port, a make of the first node or first port, a speed of the first port or first node, protocols supported by the first node or first port, or other information useful to a network user. Each identification message may contain statistical information about the first node and first port, including, for example, a number of frames sent from the first port or first node, a number of frames received by the first port or first node, the time the identification message was sent, or a number of frames lost. The statistics will be maintained by the first node and may be calculated over some a period of time, which may be set by the user or may be fixed. Preferably, the reserved multicast address is only used by nodes that support the method. The reserved multicast address may be set by the manufacturer of the node or by the user.

After the identification message is sent from the first port on the first node, it may be received by a second port on a second node, where the second port is physically connected to the first port. If the second node supports the system and method it will recognize and process the message. If the second node recognizes the message it will extract and log the information contained in the message. If the second node does not support the method it may not recognize the identification message and will typically forward the identification message to another node. The second node may also log the time the identification message was received. Furthermore, the second node will maintain a log of received information for each of its ports. For example, if the second node has twenty-four ports it will maintain twenty-four logs. These logs may be stored in memory or on disk. The logged information may be flushed periodically by the node or in response to a user command. The logged information will describe how each second port is physically connected to a first port in the system, characteristic information about the first node, and statistical information about the first node.

The first node may continue to send identification messages. The first node may send identification messages at the expiration of a delay. The delay may be a fixed or random value. The delay may be set by the user of the network, or may be set by the first node based on some characteristic of the node, such as the MAC address. A clock in the first node may count the delay. If the first node has a CPU, the clock of the CPU may be used to count the delay. The method may be implemented as a stand-alone circuit, with the circuit including a clock to count the delay. Near the end of the delay the first node will send another identification message. If the system and method is implemented in an asynchronous fashion, the exactness of timing is not critical. This periodic transmission of identification messages may be continuous, or it may be started and stopped by the user. The user may issue a command to the node to start or stop sending identification messages. The user may also direct the node to send a fixed number of identification messages. This may help limit network traffic.

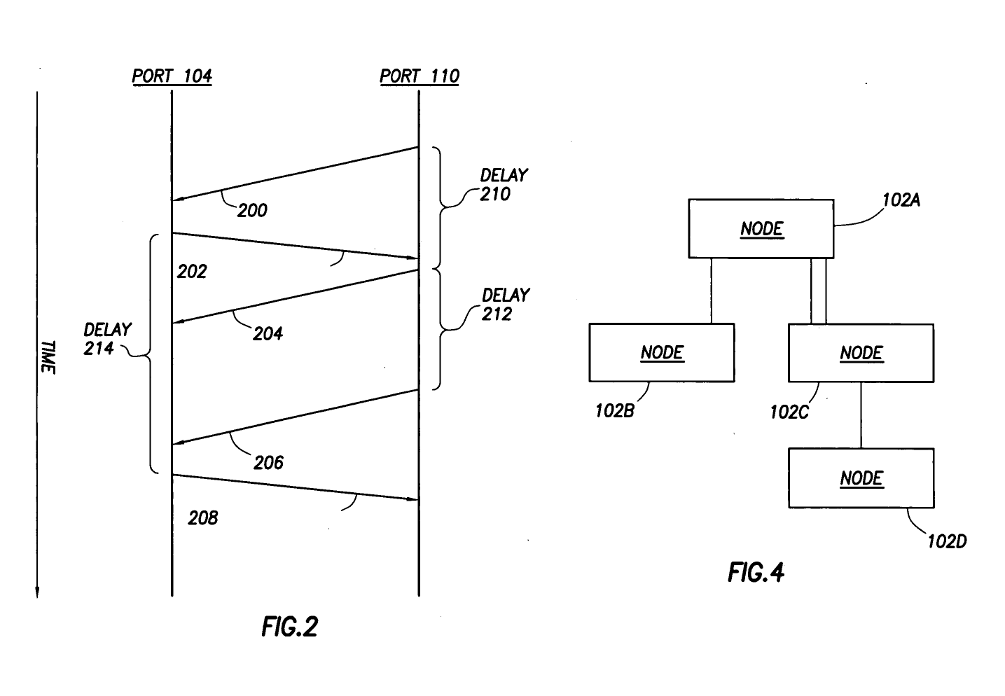

Shown in FIG. 2 is a timing diagram of transmissions between node 104 and node 110. Transmissions 202 and 208 from node 104 to node 110 are spaced by a delay 214. Transmissions 200 and 204 from node 110 to node 104 are space by a delay 210. Transmissions 204 and 206 from node 110 to node 104 are spaced by a delay 212, which is almost equivalent to delay 210. This figure demonstrates that two nodes may have different delays. FIG. 2 also demonstrates that nodes implement the method independently, e.g., the transmissions from node 104 to node 110 are neither influenced by, nor depend upon, transmissions from node 110 to node 104.

Each port of each node that supports the system and method may send and receive identification messages and log the information within the received identification messages. At some time, an administrator may access the logged information. The administrator may be any device capable of collecting and storing logged information from the nodes. For example, the administrator may be a computer or another type of information handling system. The administrator may access the logged information though a console interface to each node. Alternatively, a Management Information Base (MIB) for the logged information could be implemented in each node. The administrator may then access the logged information using a Simple Network Management Protocol (SNMP) query to each node. Alternatively, the nodes may periodically send logged information to the administrator. The administrator may send a message to a broadcast or multicast address directing the nodes to send logged information to the administrator. In response to that message, the nodes may send logged information to the administrator.

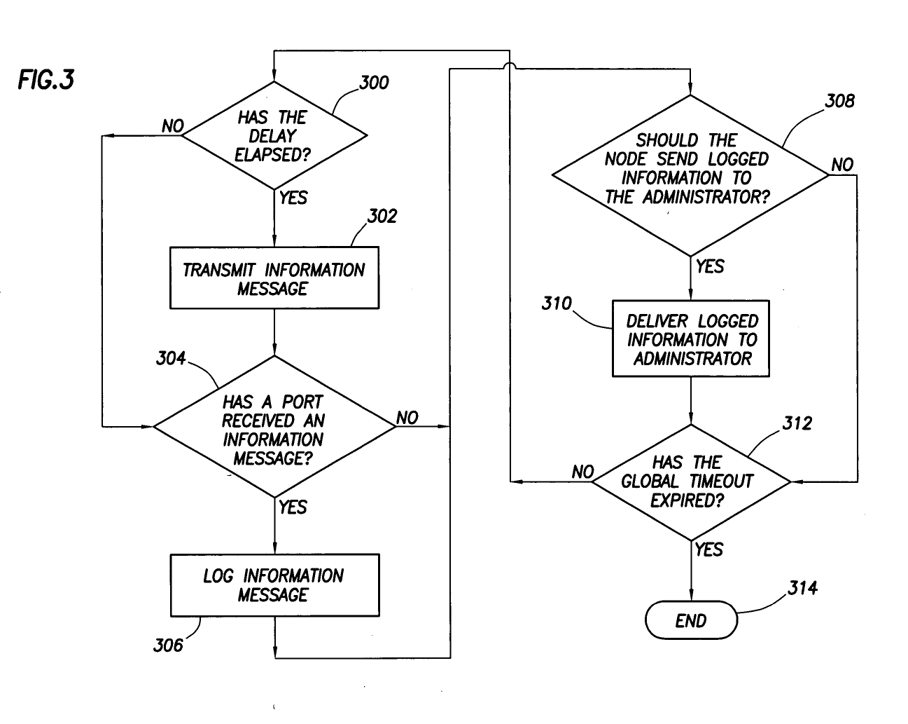

Once the administrator has collected logged information from the nodes it may process the logged information to determine the topography of the network. For example, if the identification information received from node 102A indicates that port 106 received identification information from port 112 of node 102C, then the administrator may determine that these two ports of these two nodes are physically linked nearest neighbors. The administrator may continue to process received logged information to determine all the physical links between ports. Once the physical links are determined, the administrator may render the information in any form, including a graphical form, as illustrated in FIG. 4. If the class of the node or other characteristic information is included in the identification messages, and thus logged by the nodes and collected by the administrator, the administrator may overlay this information. If statistical information is includes in the identification message, and thus logged by the nodes and collected by the administrator, the administrator may overlay this information. The administrator may save this topography in memory or to disk. The administrator may regularly determine the topography of the network. Alternatively, the administrator may only determine the topography of the network responsive to a user command.

Nodes that do not support the system and method will not collect identification information, consequently, the administrator will not be able to access identification information from these nodes. Nonetheless, the administrator may be able to determine the existence of nodes that do not support the system and method using a timing analysis. If the identification information includes the time the message is sent from the first node and the second node records the time the message is received the administrator can calculate a transit time for the message using subtraction. If the transit time is long enough to infer a switching delay between the first and second nodes, the administrator may deduce that there is another node between the first and second node.

Shown in FIG. 3 is an example of the method used by each node in the system that supports the method. Stating at block 300, the node determines if the delay has elapsed. If the delay has elapsed the node proceeds to block 302. If the delay has not elapsed the node proceeds to block 304. In block 302, the node transmits the information message from a port on the node. In block 304, the node determines if the port has received the information message from another node. If the node has received the information message the node proceeds to block 306. If the node has not received the information message the node proceeds to block 308. In block 306 the node logs the information contained in the information message. In block 308 the node determines if it should deliver logged information to the administrator. If the block should deliver logged information to the administrator, the node proceeds to block 310. If the node should not deliver logged information to the administrator the node proceeds to block 312. In block 310 the node delivers logged information to the administrator. In block 312 the node determines if a global timeout has expired. If the global timeout has elapsed the node proceeds to block 314, where the node halts, otherwise the node proceeds back to block 300.

The administrator may use current and saved network topographies to determine network faults. For example, if a physical link existed between port 108 and port 114 in a saved network topography, but in the current network topography the physical link is not present the administrator may deduce that either port 108, port 114, or communications link 113 has problems (or that they all have problems). In another example, if previously all nodes were in a saved network topography, but in the current network topography only nodes 102A and 102B exist, the administrator may deduce that either or both nodes 102C or 102D have problems.

The system and method may be implemented as software or firmware, stored and executed by the nodes. The logic, however, may also be implemented as hardware within the nodes. The hardware implementation may be less taxing on the nodes resources, such as its processor and memory. Although the present disclosure has been described in detail, it should be understood that various changes, substitutions, and alterations can be made hereto without departing from the spirit and the scope of the invention as defined by the appended claims.

1. A communications network, comprising:
a first node having a first port;
a second node having a second port, wherein the second port is connected to the first port by a communications link;
wherein:
the first node transmit a first identification message from the first port, the identification message addressed to an address, the identification message comprising only one frame;
the second node receives the identification message on the second port;
the second node logs the identification information; and
the second node delivers the identification information to an administrator, the administrator operable to determine that the first node and the second node are physically connected.

2. The communications network of claim 1, wherein the address is a multicast address.

3. The communications network of claim 1, wherein the node transmits the first message at an expiration of a delay.

4. The communications network of claim 1, wherein the first message is sent responsive to a user command.

5. The communications network of claim 1, wherein the identification information comprises an IP address.

6. The communications network of claim 1, wherein the identification information comprises a MAC address.

7. The communications network of claim 1, wherein:
the first identification message further comprises statistical information about the first node and the first port ; and
the second identification message further comprises statistical information about the second node and the second port.

8. The communications network of claim 1, wherein:
the first identification message further comprises characteristic information about the first node and the first port;
the second identification messages further comprises characteristic information about the second node and the second port.

9. The communications network of claim 1, wherein:
the node is operable to receive a command;
the node, in response to the command, sends the identification information to an administrator.

10. A method for determining a network topography, comprising the steps of:
transmitting from a first port on a first node, an identification message, the identification message comprising only one frame and containing identification information;
receiving on a second port of a second node, the identification message;
logging the identification information;
delivering the logged identification information to an administrator;
determining a nearest neighbor for the first node, where the nearest neighbor has received an identification message from the first node, or the nearest neighbor has received an identification message from the first node.

11. The method of claim 10, wherein the identification message is addressed to a multicast address.

12. The method of claim 10, further comprising waiting for the expiration of a delay before transmitting the message.

13. The method of claim 10, further comprising waiting for a user command before transmitting the message.

14. The method of claim 10, wherein the identification information comprises an IP address.

15. The method of claim 10, wherein the identification information comprises a MAC address.

16. The method of claim 10, wherein the-identification information comprises statistical information.

17. The method of claim 10, wherein the identification information comprises characteristic information.

18. An information handling system, comprising:
a first node having a first port, the first node operable to be connected in a computer network comprising a second node, the second node having a second port;
wherein the first node is operable to:
transmit a first message a first identification message, the first identification messaged addressed to an address, the first identification message comprising only one frame;
receive a second message on the first port, the second message addressed to the address, the second message comprising identification information about a second node in the communication network, the second node having a second port, the second message comprising only one frame;
log the identification information; and
deliver the identification information to an administrator, the administrator operable to determine that the first node and the second node are physically connected.

19. The information handling system of claim 18, wherein the identification information comprises an IP address.

20. The information handling system of claim 18, wherein the administrator is operable to detect non-participating nodes in the network.
